(19) United States
(12) Patent Application Publication
(10) Pub. No.: US 2013/0169144 A1
(43) Pub. Date: Jul. 4, 2013

(54) LED PACKAGE STRUCTURE CAPABLE OF ADJUSTING THE SPATIAL COLOR UNIFORMITY AND THE LIGHT DISTRIBUTION CURVE

(71) Applicants: KAO-HSU CHOU, TAIPEI CITY (TW); CHIA-LUNG HSUEH, YILAN COUNTY (TW); YI-JU LI, YILAN COUNTY (TW); SHIH-MIN WU, TAOYUAN COUNTY (TW); DAWSON LIU, TAIPEI CITY (TW)

(72) Inventors: KAO-HSU CHOU, TAIPEI CITY (TW); CHIA-LUNG HSUEH, YILAN COUNTY (TW); YI-JU LI, YILAN COUNTY (TW); SHIH-MIN WU, TAOYUAN COUNTY (TW); DAWSON LIU, TAIPEI CITY (TW)

(73) Assignee: LUSTROUS TECHNOLOGY LTD., NEW TAIPEI CITY (TW)

(21) Appl. No.: 13/342,365

(22) Filed: Jan. 3, 2012

(51) Int. Cl. H01J 1/62

(52) U.S. Cl. 313/498

(57) ABSTRACT

A LED package structure capable of adjusting the spatial color uniformity and the light distribution curve includes a substrate unit, a light-emitting unit, a transparent package unit, and a phosphor package unit. The light-emitting unit includes at least one light-emitting element for generating a light-emitting source to show a predetermined light distribution curve. The transparent package unit includes a transparent package resin body covering the light-emitting element. The phosphor package unit includes a phosphor package resin body covering the transparent package resin body. Hence, when the light-emitting source generated by the light-emitting element is transformed into a light-projecting source through the transparent package resin body and the phosphor package resin body sequentially, and the spatial color uniformity and the light distribution curve of the light-projecting source can be adjusted according to the phosphor package resin body having a non-uniform thickness.

### BACKGROUND OF THE INVENTION

1. Field of the Invention

The instant disclosure relates to a LED package structure, and more particularly, to a LED package structure capable of adjusting the spatial color uniformity and the light distribution curve.

2. Description of Related Art

The invention of the lamp greatly changes the style of building construction and the lifestyle of human beings, allowing people to work during the night. Traditional lighting devices such as lamps that adopt incandescent bulbs, fluorescent bulbs, or power-saving bulbs have been generally well-developed and used intensively for indoor illumination.

Moreover, compared to the newly developed light-emitting-diode (LED) lamps, these traditional lamps have the disadvantages of quick attenuation, high power consumption, high heat generation, short service life, high fragility, and being not recyclable. Thus, various high-powered LED structures are created to replace the traditional light-emitting sources. However, the spatial color uniformity and the light distribution curve of the traditional LED structure cannot be adjusted.

### SUMMARY OF THE INVENTION

One aspect of the instant disclosure relates to a LED package structure capable of adjusting the spatial color uniformity and the light distribution curve.

One of the embodiments of the instant disclosure provides a LED package structure capable of adjusting the spatial color uniformity and the light distribution curve, comprising: a substrate unit, a light-emitting unit, a transparent package unit, and a phosphor package unit. The substrate unit includes at least one substrate body. The light-emitting unit includes at least one light-emitting element disposed on the substrate body and electrically connected to the substrate body, wherein a light-emitting source generated by the light-emitting element shows a predetermined light distribution curve. The transparent package unit includes a transparent package resin body formed on the substrate body to cover the light-emitting element, wherein the transparent package resin body has a fixing camber formed on the top surface thereof, and the transparent package resin body has a fixed thickness. The phosphor package unit includes a phosphor package resin body formed on the substrate body to cover the transparent package resin body, wherein the phosphor package resin body has an adjustable camber formed on the top surface thereof and adjusted according the predetermined light distribution curve shown by the light-emitting source, and the thickness of the phosphor package resin body is adjusted to form a non-uniform thickness according to a non-uniform height of the adjustable camber of the phosphor package resin body relative to the substrate body. Hence, the light-emitting source generated by the light-emitting element is transformed into a light-projecting source through the transparent package resin body and the phosphor package resin body sequentially, and the spatial color uniformity and the light distribution curve of the light-projecting source is adjusted according to the phosphor package resin body having the non-uniform thickness.

Another one of the embodiments of the instant disclosure provides a LED package structure capable of adjusting the spatial color uniformity and the light distribution curve, comprising: a substrate unit, a light-emitting unit, a transparent package unit, and a phosphor package unit. The substrate unit includes at least one substrate body. The light-emitting unit includes at least one light-emitting element disposed on the substrate body and electrically connected to the substrate body. The transparent package unit includes a transparent package resin body formed on the substrate body to cover the light-emitting element, wherein the light-emitting source generated by the light-emitting element passes through the transparent package resin body to form a light-passing source that shows a predetermined light distribution curve, the transparent package resin body has an adjustable camber formed on the top surface thereof and adjusted according the predetermined light distribution curve shown by the light-passing source, and the transparent package resin body has an adjustable thickness. The phosphor package unit includes a phosphor package resin body formed on the substrate body to cover the transparent package resin body, wherein the phosphor package resin body has a fixed camber formed on the top surface thereof, and the thickness of the phosphor package resin body is adjusted to form a non-uniform thickness according to a non-uniform height of the adjustable camber of the transparent package resin body relative to the substrate body. Hence, the light-emitting source generated by the light-emitting element is transformed into a light-projecting source through the transparent package resin body and the phosphor package resin body sequentially, and the spatial color uniformity and the light distribution curve of the light-projecting source is adjusted according to the phosphor package resin body having the non-uniform thickness.

Therefore, because the thickness of the phosphor package resin body can be adjusted to form the non-uniform thickness according to the non-uniform height of the adjustable camber of the transparent package resin body relative to the substrate body, the spatial color uniformity and the light distribution curve of the light-projecting source can be adjusted according to the phosphor package resin body with provided the non-uniform thickness.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a lateral, cross-sectional, schematic view of the LED package structure before covering the phosphor package resin body on the transparent package resin body according to the first embodiment of the instant disclosure;

FIG. 1B shows a lateral, cross-sectional, schematic view of the LED package structure according to the first embodiment of the instant disclosure;

FIG. 1C shows a color space distribution diagram of the LED package structure according to the first embodiment of the instant disclosure;

FIG. 1D shows a light distribution curve diagram of the LED package structure according to the first embodiment of the instant disclosure;

FIG. 2 shows a lateral, cross-sectional, schematic view of the LED package structure according to the second embodiment of the instant disclosure;

FIG. 3A shows a lateral, cross-sectional, schematic view of the LED package structure before covering the phosphor package resin body on the transparent package resin body according to the third embodiment of the instant disclosure; and

FIG. 3B shows a lateral, cross-sectional, schematic view of the LED package structure according to the third embodiment of the instant disclosure.

### DETAILED DESCRIPTION OF THE PREFERRED EMBODIMENTS

### First Embodiment

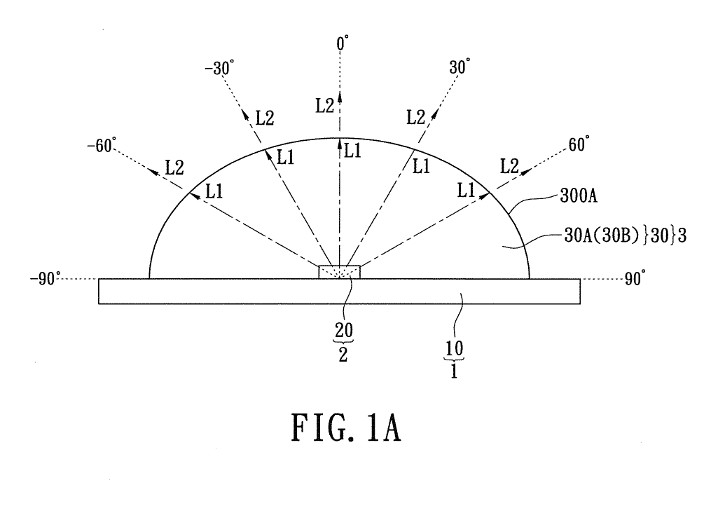

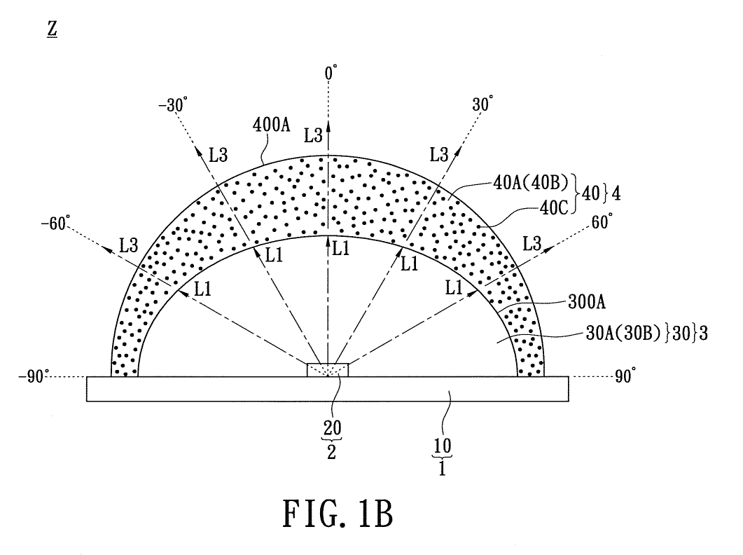

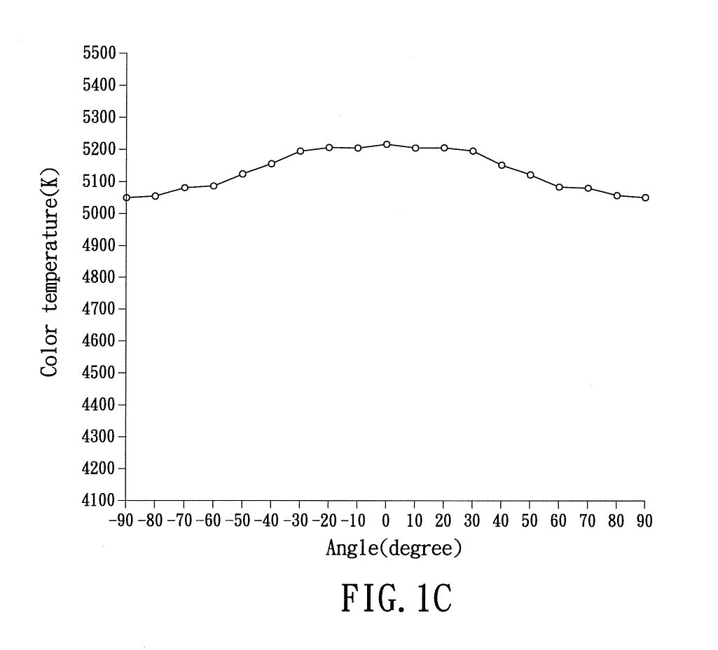

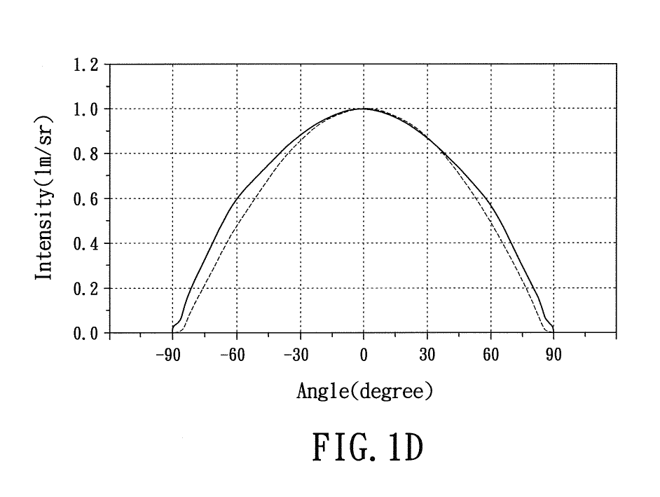

Referring to FIG. 1A to FIG. 1C, where the first embodiment of the instant disclosure provides a LED package structure Z capable of adjusting the spatial color uniformity and the light distribution curve, comprising: a substrate unit 1, a light-emitting unit 2, a transparent package unit 3, and a phosphor package unit 4.

The substrate unit 1 includes at least one substrate body 10. For example, the substrate body 10 may be a circuit substrate, and the circuit substrate has a plurality of conductive traces (not shown) formed thereon.

The light-emitting unit 2 includes at least one light-emitting element 20 disposed on the substrate body 10 and electrically connected to the substrate body 10, where a light-emitting source L1 generated by the light-emitting element 20 can show or present a predetermined light distribution curve, and the predetermined light distribution curve shows different luminous intensity (lm/sr or candela) correspondingly according to different light-emitting angles. Of course, the first embodiment can use a plurality of light-emitting elements 20 disposed on the substrate body 10 and electrically connected to the substrate body 10. For example, the light-emitting element 20 may be a blue LED bare die, and the light-emitting element 20 can be electrically connected to the substrate body 10 by a wire-bonding manner or a flip-chip manner.

The transparent package unit 3 includes a transparent package resin body 30 formed on the substrate body 10 to cover or enclose the light-emitting element 20 as shown in FIG. 1A. The transparent package resin body 30 has a fixing camber 300A formed on the top surface thereof, and the transparent package resin body 30 has a fixed thickness without adjusting. In addition, the transparent package resin body 30 may be a transparent colloid body formed by silicone 30A or epoxy 30B according to different requirements. For example, first, liquid silicone or liquid epoxy can be formed on the substrate body 10 to cover the light-emitting element 20 by adhesive dripping or press molding, and then liquid silicone or liquid epoxy can be baked (or cured) to form the solidified transparent package resin body 30 made of the silicone 30A or the epoxy 30B.

The phosphor package unit 4 includes a phosphor package resin body 40 formed on the substrate body 10 to cover or enclose the transparent package resin body 30 as shown in FIG. 1B. The phosphor package resin body 30 has an adjustable camber 400A formed on the top surface thereof, and the adjustable camber 400A can be adjusted according the predetermined light distribution curve shown by the light-emitting source L1 generated by the light-emitting element 20. The thickness of the phosphor package resin body 40 can be adjusted to form a non-uniform thickness according to a non-uniform height of the adjustable camber 400A of the phosphor package resin body 40 relative to the substrate body 10. In addition, the phosphor package resin body 40 may be a phosphor colloid body formed by mixing silicone 40A and a plurality of phosphor particles 40C or by mixing epoxy 40B and a plurality of phosphor particles 40C according to different requirements. For example, first, liquid silicone having the phosphor particles 40C or liquid epoxy having the phosphor particles 40C can be formed on the substrate body 10 to cover the transparent package resin body 30 by adhesive dripping or press molding, and then liquid silicone or liquid epoxy can be baked (or cured) to form the solidified phosphor package resin body 40 formed by mixing the silicon 40A and the phosphor particles 40C or by mixing the epoxy 40B and the phosphor particles 40C.

Hence, the light-emitting source L1 generated by the light-emitting element 20 can be transformed into a light-projecting source L3 (as shown in FIG. 1B) through the transparent package resin body 30 and the phosphor package resin body 40 sequentially, and the spatial color uniformity and the light distribution curve of the light-projecting source L3 can be adjusted according to the phosphor package resin body 40 having the non-uniform thickness. In other words, when the light-emitting source L1 generated by the light-emitting element 20 passes through the transparent package resin body 30 and the phosphor package resin body 40 sequentially, the light-emitting source L1 can be transformed into the light-projecting source L3 that can be projected outwardly from the adjustable camber 400A of the phosphor package resin body 40. In addition, the non-uniform thickness of the phosphor package resin body 40 can be adjusted according to the non-uniform height of the adjustable camber 400A of the phosphor package resin body 40 relative to the substrate body 10, thus the spatial color uniformity (as shown in FIG. 1C) and the light distribution curve (as shown in FIG. 1D) of the light-projecting source L3 can be adjusted according to the phosphor package resin body 40 having the non-uniform thickness.

For example, first, the light-emitting element 20 is electrically connected to the substrate body 10, and then the predetermined light distribution curve can be obtained from the light-emitting source L 1 generated by the light-emitting element 20. Next, the light-emitting element 20 is covered by the transparent package resin body 30, and then the transparent package resin body 30 is covered by the phosphor package resin body 40. Afterward, the thickness of the phosphor package resin body 40 is adjusted to form a non-uniform thickness according to the non-uniform height of the adjustable camber 400A of the phosphor package resin body 40 relative to the substrate body 10. For instance, referring to FIG. 1B, the adjustable camber 400A of the phosphor package resin body 40 is extended gradually away from the fixing camber 300A of the transparent package resin body 30 in a direction away from the substrate body 10, thus the non-uniform thickness of the phosphor package resin body 40 is increased gradually in a direction away from the substrate body 10. Finally, the light-projecting source L3 can show a predetermined spatial color uniformity (as shown in FIG. 1C) and a predetermined light distribution curve (as shown in FIG. 1D) as designer's wish according to the phosphor package resin body 40 having the non-uniform thickness.

Of course, referring to FIG. 1A, the light-emitting source L1 generated by the light-emitting element 20 can pass through the transparent package resin body 40 to form a light-passing source L2 that can show or present a predetermined light distribution curve. Hence, referring to FIG. 1B, the phosphor package resin body 40 has an adjustable camber 400A formed on the top surface thereof, and the adjustable camber 400A also can be adjusted according the predetermined light distribution curve shown by the light-passing source L2, and the thickness of the phosphor package resin body 40 can be adjusted to form a non-uniform thickness according to a non-uniform height of the adjustable camber 400A of the phosphor package resin body 40 relative to the substrate body 10. Hence, because the thickness of the phosphor package resin body 40 can be adjusted to form a non-uniform thickness according to the non-uniform height of the adjustable camber 400A of the phosphor package resin body 40 relative to the substrate body 10, the spatial color uniformity (as shown in FIG. 1C) and the light distribution curve (as shown in FIG. 1D) of the light-projecting source L3 can be adjusted according to the phosphor package resin body 40 having the non-uniform thickness. In other words, the adjustable camber 400A of the phosphor package resin body 40 can be adjusted according the predetermined light distribution curve shown by the light-passing source L2 or the light-emitting source L1.

### Second Embodiment

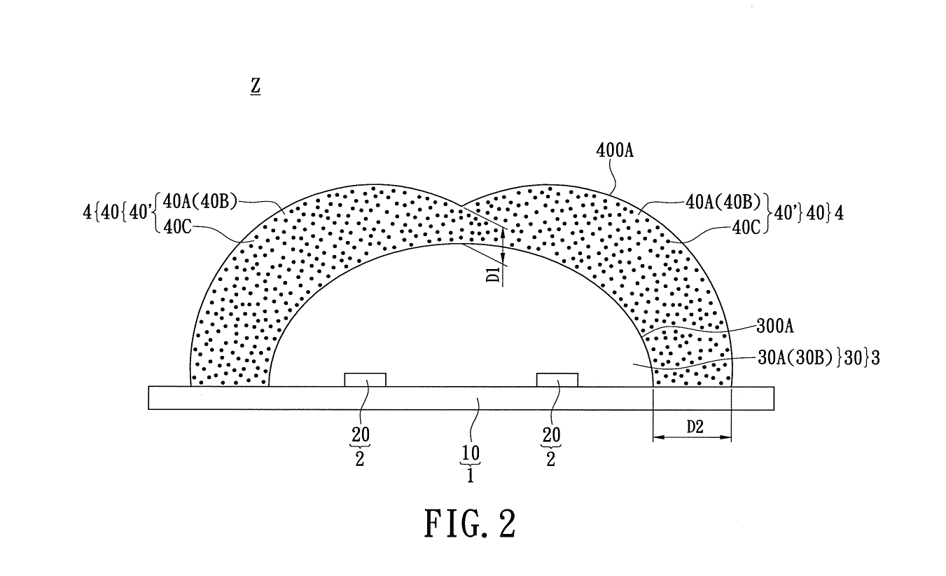

Referring to FIG. 2, where the second embodiment of the instant disclosure provides a LED package structure Z capable of adjusting the spatial color uniformity and the light distribution curve. Comparing FIG. 2 with FIG. 1B, the difference between the second embodiment and the first embodiment is as follows: in the second embodiment, the light-emitting unit 2 includes at least two light-emitting elements 20 disposed on the substrate body 10 and electrically connected to the substrate body 10. The phosphor package resin body 40 can be divided into at least two symmetrical phosphor layers 40′. A junction of the at least two phosphor layers 40′ has a first thickness D1, each phosphor layer 40′ has a second thickness D2 formed on one end thereof for contacting the substrate body 10, and the first thickness D1 is smaller than the second thickness D2. Moreover, the thickness of the phosphor package resin body 40 can be adjusted to form a non-uniform thickness according to the non-uniform height of the adjustable camber 400A of the phosphor package resin body 40 relative to the substrate body 10, thus the spatial color uniformity and the light distribution curve of the light-projecting source L3 can be adjusted according to the phosphor package resin body 40 having the non-uniform thickness.

### Third Embodiment

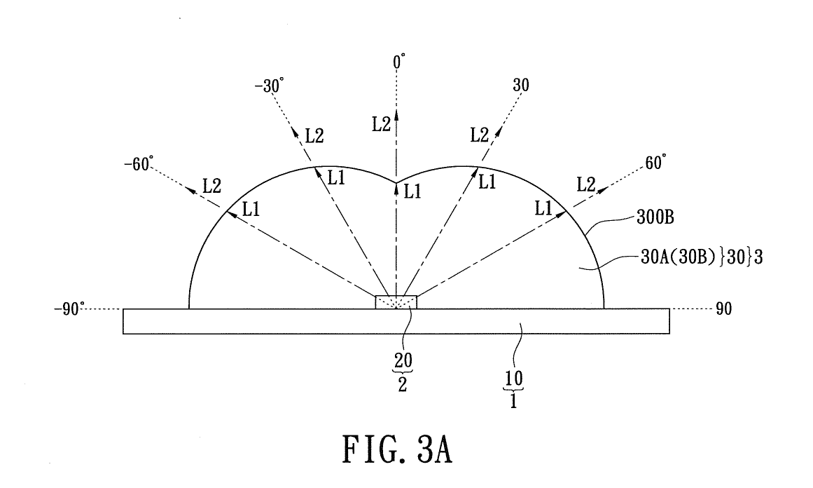

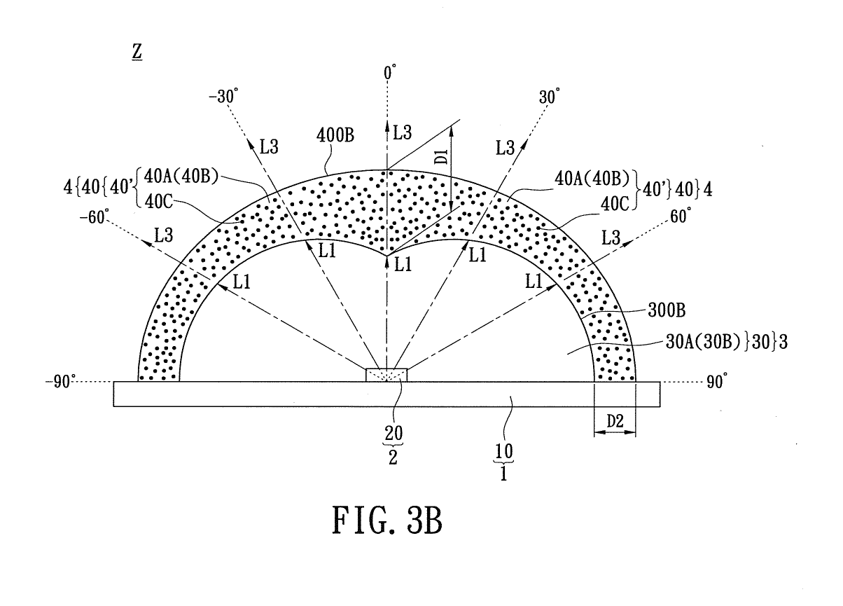

Referring to FIG. 3A and FIG. 3B, where the third embodiment of the instant disclosure provides a LED package structure Z capable of adjusting the spatial color uniformity and the light distribution curve. Comparing FIG. 3A with FIG. 1A and comparing FIG. 3B with FIG. 1B, the difference between the third embodiment and the first embodiment is as follows: in the third embodiment, the light-emitting source L 1 generated by the light-emitting element 20 passes through the transparent package resin body 30 to form a light-passing source L2 that can show or present a predetermined light distribution curve, where the transparent package resin body 30 has an adjustable camber 300B formed on the top surface thereof and the adjustable camber 300B can be adjusted according the predetermined light distribution curve shown by the light-passing source L2, and the transparent package resin body 30 has an adjustable thickness. In addition, the phosphor package resin body 40 has a fixed camber 400B formed on the top surface thereof, and the thickness of the phosphor package resin body 40 can be adjusted to form a non-uniform thickness according to a non-uniform height of the adjustable camber 300B of the transparent package resin body 30 relative to the substrate body 10. For example, the phosphor package resin body 40 can be divided into at least two symmetrical phosphor layers 40′. A junction of the at least two phosphor layers 40′ has a first thickness D1, each phosphor layer 40′ has a second thickness D2 formed on one end thereof for contacting the substrate body 10, and the first thickness D1 is larger than the second thickness D2.

Hence, when the light-emitting source L1 generated by the light-emitting element 20 is transformed into the light-projecting source L3 through the transparent package resin body 30 and the phosphor package resin body 40 sequentially, the spatial color uniformity and the light distribution curve of the light-projecting source L3 can be adjusted according to the phosphor package resin body 40 having the non-uniform thickness.

In conclusion, because the thickness of the phosphor package resin body can be adjusted to form the non-uniform thickness according to the non-uniform height of the adjustable camber of the transparent package resin body relative to the substrate body, the spatial color uniformity and the light distribution curve of the light-projecting source can be adjusted according to the phosphor package resin body with provided the non-uniform thickness.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A LED package structure capable of adjusting the spatial color uniformity and the light distribution curve, comprising:
a substrate unit including at least one substrate body;
a light-emitting unit including at least one light-emitting element disposed on the at least one substrate body and electrically connected to the substrate body, wherein a light-emitting source generated by the at least one light-emitting element shows a predetermined light distribution curve;
a transparent package unit including a transparent package resin body formed on the at least one substrate body to cover the at least one light-emitting element, wherein the transparent package resin body has a fixing camber formed on the top surface thereof, and the transparent package resin body has a fixed thickness; and
a phosphor package unit including a phosphor package resin body formed on the at least one substrate body to cover the transparent package resin body, wherein the phosphor package resin body has an adjustable camber formed on the top surface thereof and adjusted according the predetermined light distribution curve shown by the light-emitting source, and the thickness of the phosphor package resin body is adjusted to form a non-uniform thickness according to a non-uniform height of the adjustable camber of the phosphor package resin body relative to the at least one substrate body;
wherein the light-emitting source generated by the at least one light-emitting element is transformed into a light-projecting source through the transparent package resin body and the phosphor package resin body sequentially, and the spatial color uniformity and the light distribution curve of the light-projecting source is adjusted according to the phosphor package resin body having the non-uniform thickness.

2. The LED package structure of claim 1, wherein the at least one substrate body is a circuit substrate, and the at least one light-emitting element is a blue LED bare die.

3. The LED package structure of claim 1, wherein the transparent package resin body is formed by silicone or epoxy.

4. The LED package structure of claim 1, wherein the phosphor package resin body is formed by mixing silicone and a plurality of phosphor particles or by mixing epoxy and a plurality of phosphor particles.

5. The LED package structure of claim 1, wherein the adjustable camber of the phosphor package resin body is extended gradually away from the fixing camber of the transparent package resin body in a direction away from the at least one substrate body, thus the non-uniform thickness of the phosphor package resin body is increased gradually in a direction away from the at least one substrate body.

6. The LED package structure of claim 1, wherein the phosphor package resin body is divided into at least two phosphor layers, a junction of the at least two phosphor layers has a first thickness, each phosphor layer has a second thickness formed on one end thereof for contacting the at least one substrate body, and the first thickness is smaller than the second thickness.

7. A LED package structure capable of adjusting the spatial color uniformity and the light distribution curve, comprising:
a substrate unit including at least one substrate body;
a light-emitting unit including at least one light-emitting element disposed on the at least one substrate body and electrically connected to the substrate body;
a transparent package unit including a transparent package resin body formed on the at least one substrate body to cover the at least one light-emitting element, wherein the transparent package resin body has a fixing camber formed on the top surface thereof, the transparent package resin body has a fixed thickness, and the light-emitting source generated by the at least one light-emitting element passes through the transparent package resin body to form a light-passing source that shows a predetermined light distribution curve; and
a phosphor package unit including a phosphor package resin body formed on the at least one substrate body to cover the transparent package resin body, wherein the phosphor package resin body has an adjustable camber formed on the top surface thereof and adjusted according the predetermined light distribution curve shown by the light-passing source, and the thickness of the phosphor package resin body is adjusted to form a non-uniform thickness according to a non-uniform height of the adjustable camber of the phosphor package resin body relative to the at least one substrate body;
wherein the light-emitting source generated by the at least one light-emitting element is transformed into a light-projecting source through the transparent package resin body and the phosphor package resin body sequentially, and the spatial color uniformity and the light distribution curve of the light-projecting source is adjusted according to the phosphor package resin body having the non-uniform thickness.

8. The LED package structure of claim 7, wherein the adjustable camber of the phosphor package resin body is extended gradually away from the fixing camber of the transparent package resin body in a direction away from the at least one substrate body, thus the non-uniform thickness of the phosphor package resin body is increased gradually in a direction away from the at least one substrate body.

9. The LED package structure of claim 7, wherein the phosphor package resin body is divided into at least two phosphor layers, a junction of the at least two phosphor layers has a first thickness, each phosphor layer has a second thickness formed on one end thereof for contacting the at least one substrate body, and the first thickness is smaller than the second thickness.

10. A LED package structure capable of adjusting the spatial color uniformity and the light distribution curve, comprising:
a substrate unit including at least one substrate body;
a light-emitting unit including at least one light-emitting element disposed on the at least one substrate body and electrically connected to the substrate body;
a transparent package unit including a transparent package resin body formed on the at least one substrate body to cover the at least one light-emitting element, wherein the light-emitting source generated by the at least one light-emitting element passes through the transparent package resin body to form a light-passing source that shows a predetermined light distribution curve, the transparent package resin body has an adjustable camber formed on the top surface thereof and adjusted according the predetermined light distribution curve shown by the light-passing source, and the transparent package resin body has an adjustable thickness; and
a phosphor package unit including a phosphor package resin body formed on the at least one substrate body to cover the transparent package resin body, wherein the phosphor package resin body has a fixed camber formed on the top surface thereof, and the thickness of the phosphor package resin body is adjusted to form a non-uniform thickness according to a non-uniform height of the adjustable camber of the transparent package resin body relative to the at least one substrate body;
wherein the light-emitting source generated by the at least one light-emitting element is transformed into a light-projecting source through the transparent package resin body and the phosphor package resin body sequentially, and the spatial color uniformity and the light distribution curve of the light-projecting source is adjusted according to the phosphor package resin body having the non-uniform thickness.
